(19) United States
(12) Patent Application Publication
(10) Pub. No.: US 2006/0029815 A1
(43) Pub. Date: Feb. 9, 2006

(54) Substrate coating

(76) Inventors: Daniel P. Woodruff, Lakeville, MN (US); William A. Meredith, Faribault, MN (US); Chanin D. Cloutier, Faribault, MN (US)

Correspondence Address: DORSEY & WHITNEY LLP;INTELLECTUAL PROPERTY DEPARTMENT, 50 SOUTH SIXTH STREET, MINNEAPOLIS, MN, 55402-1498, US

(21) Appl. No.: 11/184,539

(22) Filed: Jul. 19, 2005

Related U.S. Application Data
(60) Provisional application No. 60/589,780, filed on Jul. 21, 2004.

(51) Int. Cl. B32B 17/06

(52) U.S. Cl. 428/426

(57) ABSTRACT

A substrate coating and method of applying the same in which the coating provides UV blocking and AR properties and in which at least one of the layers is formed of a combination of zinc oxide and a stabilizing secondary metal oxide.

### CROSS-REFERENCE TO RELATED APPLICATION

This application claims priority to U.S. Provisional Application Ser. No. 60/589,780, filed on Jul. 21, 2004, the contents of which is incorporated herein by reference in its entirety.

### BACKGROUND OF THE INVENTION

1. Field of the Invention

The present invention relates to a coating for a substrate and more particularly a coating for a transparent or substantially transparent substrate which exhibits both ultraviolet (UV) and anti-reflective (AR) properties. Such a coating has various uses, but has particular application in the framing of pictures or artwork.

2. Description of the Prior Art

It is known that exposure of pictures or other artwork to ultraviolet (UV) light can result in deterioration of the picture or artwork over time. Accordingly, glass or other transparent or substantially transparent substrates used for picture or artwork framing (“framing glass”) are often treated or processed to provide a UV blocking or absorbing property. In many cases, framing glass is also treated or processed to provide an anti-reflective (AR) property on one or both sides to improve light transmission and to reduce glare and reflection on the outer surface.

The UV blocking or absorbing property is commonly applied to a framing glass via a wet process such as a dip flow, curtain, or spray, among others. This provides the framing glass with the ability to block out virtually all (as much as 97% or more) of UV light and thus protect the picture or artwork from such UV exposure and resulting deterioration. On the other hand, anti-reflective (AR) properties are often applied to framing glass by various other techniques such as vacuum sputtering. Thus, two separate processes or treatments are often required to provide framing glass with a coating that exhibits both UV blocking and AR properties.

Accordingly, there is a need in the art for a coating for framing glass, and a method of forming such coating, which provides both ultraviolet (UV) blocking as well as anti-reflective (AR) properties in a single application process.

### SUMMARY OF THE INVENTION

The present invention relates generally to a substrate coating, and more specifically, to a substrate coating for picture or artwork framing glass or other substrate. Still more specifically, the present invention relates to a coating structure, and a method of applying such coating, which provides both UV blocking as well as AR properties in a single process.

Anti-reflective (AR) coatings exist in the art and are applied to transparent, substantially transparent and light transmissive substrates for the purpose of reducing glare and reflection from the substrate surface. In addition to treatment of framing glass, a major application of AR coatings is in the display industry comprised of televisions, computer monitors, cathode ray tubes (CRTs), flat panel displays and display filters for the above, among others. One of the simplest prior art AR coatings comprises a single layer of a transparent or substantially transparent material having a refractive index less than that of the substrate on which it is applied and having an optical thickness of about one-quarter wavelength at a wavelength of about 520 nanometers. Multilayer AR coatings comprised of two or more layers of substantially transparent materials also exist. These multilayer AR coatings usually have at least one layer with a refractive index higher than the refractive index of the substrate (high refractive index material layer) and at least one other layer with a refractive index lower than the substrate (low refractive index material layer). Anti-reflective coatings are commonly applied to substrates via various techniques including vacuum sputtering.

The present invention involves applying a multilayer AR stack or coating in which one or more of the high refractive index layers is formed of an ultra-violet (UV) absorbing or blocking material or a combination of such materials.

Various high refractive index metal oxides exhibit UV blocking properties. Included among these are zinc oxide (ZnO), cerium dioxide (CeO₂), titanium dioxide (TiO₂), molybdenum oxide, tin oxide (SnO₂) and various cerium-rich and lanthanum-rich misch metals, among others. Of these, zinc oxide is clearly the best at blocking UV light. It has been found that when zinc oxide is used as the high refractive index material in a multilayer AR stack, sufficient UV blocking (as much as 97% or more) can be achieved. A problem with zinc oxide, however, is that it corrodes or deteriorates when exposed to certain environmental conditions such as salt fog or mist which is prevalent along the coasts or other locations near sea water. Thus, although zinc oxide, when used as the high refractive index material in an AR film, provides highly acceptable UV blocking properties by blocking at least 97% of the UV light to which it is exposed, it will corrode over time when exposed to salt fog or mist or the like.

In accordance with the invention, it has been found that a multilayer coating with a high refractive index layer formed of a combination of zinc oxide and one or more of the other UV absorbing metal oxides identified above results in a coating with the UV blocking benefits of zinc oxide, while limiting its negative effects. Specifically, the UV absorbing metal oxides other than zinc oxide function to sufficiently stabilize the zinc oxide to prevent corrosion or other deterioration due to salt fog or mist or the like, while still exhibiting an acceptable level of UV blocking.

Accordingly, it is an object of the present invention to provide a substrate coating which exhibits both UV blocking and AR properties and is applied in a single process.

Another object of the present invention is to provide a process for applying a UV blocking and AR coating to a substrate via a single process.

A further object of the present invention is to provide a coating to framing glass via vacuum sputtering which coating exhibits both UV blocking and AR properties.

A still further object of the present invention is to provide an AR coating to framing glass via vacuum sputtering in which one of the high refractive index material layers is comprised of a combination of UV blocking metal oxides.

A still further object of the present invention is to provide coated framing glass, and a coating for framing glass in which the coating is a multilayer coating with one of the layers comprised of a combination of zinc oxide and a UV blocking metal oxide other than zinc oxide.

These and other objects of the present invention will become apparent with reference to the description of the preferred embodiment and the appended claims.

### DESCRIPTION OF THE DRAWINGS

FIG. 1 is an illustration of a coating exhibiting both UV blocking and AR properties in accordance with the present invention.

### DESCRIPTION OF THE PREFERRED EMBODIMENT

The preferred embodiment of the present invention is directed to a coating for a substrate and more particularly a coating for a picture or artwork framing substrate which provides both ultra-violet (UV) blocking and anti-reflective (AR) properties. The invention is also directed to a process for applying such a coating.

The substrate to which the coating is applied in accordance with the present invention may include any transparent, substantially transparent or light transparent substrate such as glass, quartz or any plastic or organic polymeric substrate. Further, the substrate may be a laminate of two or more different materials and may be of a variety of thicknesses. The substrate may also be rigid or flexible and may be a substrate which includes a primed or etched surface or a surface with a chemical or other material layer applied thereon. The invention has particular application to glass or other substrates used for framing of pictures or other artwork and sometimes referred to herein as “framing glass”.

In accordance with the present invention, a multilayer AR coating is applied to the substrate in which one of the layers (and in particular at least one of the high refractive index material layers) of such coating is a metal oxide which absorbs ultra-violet light and thus is capable of providing UV blocking properties. Although various techniques can be used to apply the multilayer AR coating with the UV blocking layer, the preferred technique is via vacuum sputtering. Accordingly, the preferred embodiment and the preferred process will be described with respect to vacuum sputtering.

In conventional AR coatings, it is known that multilayer AR coatings commonly comprise alternating layers of a high refractive index and a low refractive index, with the low refractive index material having a refractive index less than the refractive index of the substrate and usually being the layer in the coating which is furthest from the substrate. Accordingly, a typical four-layer anti-reflective coating applied by sputtering would include a high refractive index material applied to the substrate, followed by a low refractive index material layer, then a high refractive index material layer, and finally a low refractive index material layer forming the outermost surface of the coating.

Certain metal oxides which have sufficiently high refractive indices and which can be sputtered also are capable of functioning to absorb or block UV light. These metal oxides which exhibit UV blocking capability include, among possible others, zinc oxide (ZnO), cerium dioxide (CeO₂), titanium dioxide (TiO₂), molybdenum oxide, tin oxide (SnO₂) and various cerium-rich and lanthanum-rich misch metals. Of these metal oxides, the one which appears to best block or absorb UV light is zinc oxide. Accordingly, use of zinc oxide as at least one of the high refractive index material layers in a four-layer (or multilayer) AR coating will provide a coating that not only exhibits AR properties, but UV blocking properties as well. However, it has been found that zinc oxide, readily corrodes and deteriorates when exposed to certain environmental conditions such as salt fog or salt water mist which is prevalent along the coasts and in other areas near sea water.

It has also been found, however, that when zinc oxide is combined with one or more other metal oxides which exhibit UV blocking capability, the zinc oxide exhibits an unexpected high degree of stability to such corrosion and deterioration, while still exhibiting acceptable levels of UV blocking capability.

More specifically, in accordance with the preferred embodiment, it has been found that a multilayer coating with one or more high refractive index material layers formed of a combination of zinc oxide and one or more of titanium dioxide, molybdenum oxide, cerium dioxide or certain other stabilizing metal oxides, as a secondary metal oxide, results in a coating (or zinc oxide containing layer) in which the zinc oxide is sufficiently stabilized from corrosion in salt fog, or other similar salty environments. Preferably, such combination should include at least 10 atomic percent of the secondary metal oxide (titanium dioxide, molybdenum oxide or cerium dioxide, etc.), more preferably, at least about 20 atomic percent or more of such secondary metal oxide and most preferably about 20 to 40 atomic percent of the secondary metal oxide. As used herein “atomic percent” means atom to atom percent. For example, a combination comprising 90 atomic percent zinc oxide and 10 atomic percent of a secondary oxide would have 90 atoms of zinc oxide and 10 atoms of the secondary oxide, regardless of their respective atomic weights.

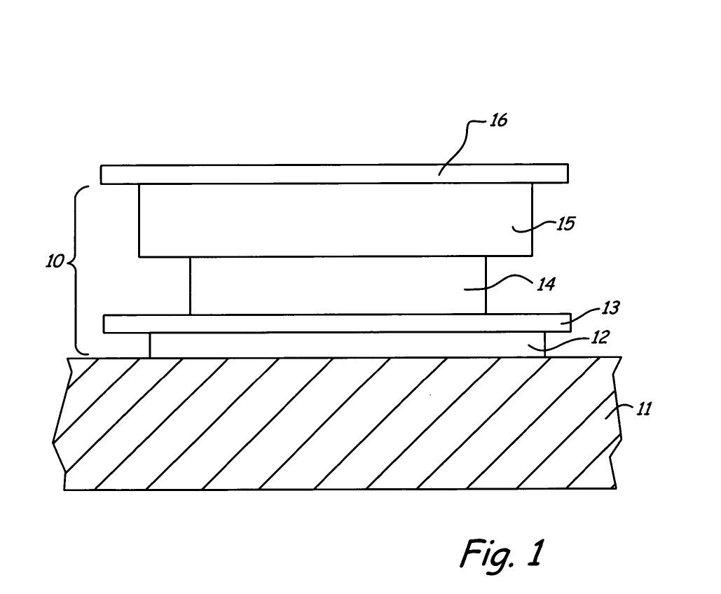

FIG. 1 illustrates a substrate coating in accordance with the present invention which exhibits both AR as well as UV blocking properties. In FIG. 1, the coating 10 is shown as being applied to the front surface of a substrate 11 which is preferably a transparent or partially transparent substrate such as glass. More preferably, the substrate is framing glass for use in displaying various artwork. The substrate 11 includes two major surfaces, front and back, with the front surface being that furthest from the artwork. The coating 10 is preferably applied to the front surface or to both the front and back surfaces of the substrate.

The coating 10 is a multilayer coating comprising a high refractive index material first layer 12 which is adjacent to the substrate 11 and which is formed of a blend of zinc oxide and one or more of a further metal oxide such as titanium dioxide, molybdenum oxide, cerium dioxide or certain other stabilizing metal oxides. Layer 13 is applied to the layer 12 and is comprised of a low refractive index material such as silicon dioxide. The layer 14 is a high refractive index material layer applied to the layer 13 and preferably comprises a blend or combination of zinc oxide and titanium dioxide, molybdenum oxide, cerium dioxide or certain other stabilizing metal oxide. Finally, the outer layer 15 is applied to the layer 14 and is comprised of a low refractive index material such as silicon dioxide.

As a further embodiment, in some cases, a thin layer 16 of a further metal oxide or other protective coating may be added to the outer layer 15 as described below. This layer 16 is a relatively thin layer, less than 10 nanometers and more preferably about 5 nanometers or less.

While there is some leeway with respect to the physical thicknesses of the individual layers 12-15, the preferred physical thickness of the layer 12 ranges from about 10 to 30 nanometers and is most preferably about 20 nanometers, the preferred physical thickness of the layer 13 range from about 20 to 50 nanometers and is most preferably about 20 nanometers, the preferred physical thickness of the layer 14 ranges from about 100 to 150 nanometers and is most preferably about 100 nanometers and the preferred physical thickness of the layer 15 ranges from about 80 to 105 nanometers and is most preferably about 92 nanometers.

Although the example shown in FIG. 1 is preferred, other AR stacks or coatings can be utilized as well by using zinc oxide or a zinc oxide blend or combination as one or more of the high refractive index material layers. Specific examples of anti-reflective stacks or coatings are disclosed in U.S. Pat. Nos. 5,091,244; 5,105,310; 5,372,874; 5,147,125; 5,372,874; 5,407,733; 5,450,238; 5,579,162 and 5,744,227, the disclosures of which are incorporated herein by reference.

Preferably, the layers 12 and 14 are high refractive index materials comprised of a zinc oxide blend or combination comprised primarily of zinc oxide, with at least about 10 atomic percent, more preferably, at least about 20 atomic percent or more of a secondary metal oxide and most preferably about 20 to 40 atomic percent of a secondary metal oxide comprised of one or more of titanium dioxide, molybdenum oxide, cerium dioxide or certain other stabilizing metal oxides. Because zinc oxide is one of the most effective metal oxides for providing UV blocking, it is preferable for the combination layer to contain as much zinc oxide as possible, provided it is sufficiently stabilized by the secondary metal oxide. Accordingly, the combination layer preferably comprises at least about 50 atomic percent zinc oxide and more preferably up to 90 atomic percent zinc oxide.

Preferably, the process in accordance with the present invention includes applying the layers in FIG. 1 by vacuum sputtering. Vacuum sputtering is a process known in the art for applying multilayer AR and other coatings.

In the preferred embodiment, the combination of the zinc oxide with the secondary metal oxide is a true, homogenous mixture and not a mixture of discrete layers. Such a homogenous mixture of the combined zinc oxide and secondary metal oxide may be formed by sputtering zinc oxide from one target and the secondary metal oxide or oxides (titanium dioxide, molybdenum oxide or cerium dioxide, etc.) from a second target, with the respective ratios of the zinc oxide and secondary oxides being controlled by varying the power to the targets. As an alternative, it is also possible to form a single target which is comprised of a combination of zinc oxide and the desired secondary oxide or oxides in the desired ratios and then sputtering the combination from the single target.

Accordingly, the structure of the UV/AR coating in accordance with the present invention includes a multilayer coating of alternating high and low refractive index material layers in which at least one of the high refractive index layers is formed of a combination of zinc oxide and a secondary metal oxide. Preferably, the secondary metal oxide is present in an amount of at least about 10 atomic percent or more, more preferably at least about 20 atomic percent or more and most preferably about 20 to 40 atomic percent. Preferably the combination is a substantially homogenous combination, without discrete layers.

The process in accordance with the preferred embodiment of the present invention includes sputtering such coating onto a substrate. When one of the high refractive index material layers is a zinc oxide combination, the combined zinc oxide and secondary oxide material layers are sputtered either from a single cathode formed of a combination of the zinc oxide and the desired secondary metal oxide materials in the desired ratio or from separate cathodes of zinc oxide and of the desired secondary metal oxide in the same vacuum chamber.

In addition to the above technique for stabilizing the zinc oxide and forming a framing glass coating exhibiting both UV blocking or AR properties, the present invention also contemplates protecting the zinc oxide in a multilayer anti-reflective coating by isolating it to avoid its exposure to salt fog or other similar environmental conditions. One means of accomplishing this is by sandwiching the zinc oxide layer between discrete protective layers of a second metal oxide or other material. Preferably, this second material is a material which also exhibits some degree of UV blocking and is either a high refractive index material layer with a refractive index greater than two, or a low refractive index material layer with a refractive index less than 1.52. Thus, this second material would form either a portion of the high refractive index material layer along with the zinc oxide, or a portion of the low refractive index material layer adjacent to the zinc oxide. Further, this second material is preferably a non-porous material so that it effectively functions to protect the zinc oxide within the coating.

A further technique for protecting the zinc oxide layer is to vary the parameters of the outer low refractive index material layer such as silicon dioxide by making it less porous. A still further technique is to apply an additional, thin metal oxide layer on the outside of the outer silicon dioxide layer in which such metal oxide layer is non-porous and is capable of protecting the zinc oxide layer from the environmental elements such as salt fog and the like.

Although the description of the preferred embodiment has been quite specific, it is contemplated that various modifications could be made without deviating from the spirit of the present invention. Accordingly, it is intended that the scope of the present invention be dictated by the appended claims rather than by the description of the preferred embodiment.

1. A substrate coating comprising a multilayer coating exhibiting both UV blocking and AR properties comprised of alternating high and low refractive index material layers in which at least one of the high refractive index material layers has a refractive index greater than the refractive index of the substrate on which it is applied and is comprised of a combination of zinc oxide and a secondary metal oxide capable of stabilizing the zinc oxide.

2. The substrate coating of claim 1 wherein the coating is a coating for framing glass.

3. The substrate coating of claim 1 wherein said secondary metal oxide is one or more of titanium dioxide, molybdenum oxide and cerium dioxide.

4. The substrate coating of claim 3 wherein said at least one high refractive index material layer is sputtered.

5. The substrate coating of claim 1 wherein said at least one high refractive index material layer is comprised of at least about 10 atomic percent of said secondary metal oxide.

6. The substrate coating of claim 5 wherein said at least one high refractive index material layer is comprised of at least about 20 atomic percent of said secondary metal oxide.

7. The substrate coating of claim 6 wherein said combination is substantially homogeneous throughout.

8. The substrate coating of claim 1 being a four layer coating in which each of said high refractive index material layers is comprised of a combination of zinc oxide and a secondary metal oxide capable of stabilizing the zinc oxide.

9. A framing glass for use in an artwork frame comprising:
a transparent or substantially transparent substrate having a major surface;
a coating on said major surface, said coating comprised of a plurality of sputtered layers, at least one of said layers comprised of a combination of zinc oxide (ZnO) and a secondary metal oxide.

10. The framing glass of claim 9 wherein said secondary metal oxide is selected from one or more of titanium dioxide, molybdenum oxide and cerium dioxide.

11. The framing glass of claim 10 wherein said at least one layer is comprised of at least about 10 atomic percent of said secondary metal oxide.

12. The framing glass of claim 11 wherein said combination is substantially homogeneous throughout.

13. A method of coating a substrate to exhibit both UV blocking and AR properties comprising:
applying a high refractive material index layer closest to the substrate and applying a low refractive index material layer onto said high refractive index material layer in which said low refractive index material has a refractive index less than the refractive index of said substrate and said high refractive index material layer is comprised of a combination of zinc oxide and a secondary metal oxide capable of stabilizing the zinc oxide against corrosion or deterioration.

14. The method of claim 13 wherein said substrate is framing glass.

15. The method of claim 14 wherein said secondary metal oxide is one or more of titanium dioxide, molybdenum oxide and cerium dioxide.

16. The method of claim 13 wherein said applying steps are via sputtering.

17. The method of claim 16 wherein said combination is substantially homogeneous throughout.

18. The method of claim 17 wherein said step of applying said high refractive index material layer is via sputtering from a cathode comprised of a combination of zinc oxide and said secondary metal oxide.

19. The method of claim 16 wherein said step of applying said high refractive index material layer is via sputtering from a first cathode of zinc oxide and a second cathode of said secondary metal oxide.

20. The method of claim 16 wherein said combination is comprised of at least about 10 atomic percent of said secondary metal oxide.

21. The method of claim 19 wherein said applying step includes applying a first high refractive index material layer closest to said substrate, applying a first low refractive index material layer to said first high refractive index material layer, applying a second high refractive index material layer to said first low refractive index material layer and applying a second low refractive index material layer to said second high refractive index material layer and wherein said first and second high refractive index material layers are each comprised of a combination of zinc oxide and a secondary metal oxide capable of stabilizing the zinc oxide against corrosion or deterioration.
